(19) United States
(12) Patent Application Publication
(10) Pub. No.: US 2006/0188632 A1
(43) Pub. Date: Aug. 24, 2006

(54) Pet treats with rough surface texture

(76) Inventors: Li Nie, Parkville, MO (US); Sukh D. Bassi, Atchison, KS (US); Clodualdo C. Maningat, Platte City, MO (US); Michael Douglas Parker, Lawrence, KS (US)

Correspondence Address: LATHROP & GAGE LC, 4845 PEARL EAST CIRCLE, SUITE 300, BOULDER, CO, 80301, US

(21) Appl. No.: 11/340,359

(22) Filed: Jan. 26, 2006

Related U.S. Application Data
(60) Provisional application No. 60/647,113, filed on Jan. 26, 2005.

(51) Int. Cl. A21D 10/00

(52) U.S. Cl. 426/549

(57) ABSTRACT

A pet treat with a rough surface texture and appearance is produced from a matrix binder and at least one granular filler having a particle size between 0.1 mm to 6 mm. The matrix binder may be selected from gelatinized starches, gelatinized flours, wheat gluten, soy protein, casein, caseinates, gelatin, hydrocolloids, gums and mixtures thereof. The granular filler may be selected from mill feeds, whole grains, distillers dried grains, pork grind, bird seed and mixtures thereof.

### RELATED APPLICATIONS

This application claims priority to U.S. Application No. 60/647,113, filed Jan. 26, 2005, which is incorporated herein by reference.

### BACKGROUND

1. Field of the Invention

The present invention pertains to pet treats and, in particular, to treats having rough surface texture and appearance, and methods of producing the same.

2. Description of the Related Art

Pet treats can be nutritional products designed for immediate consumption once presented to an animal, or functional products designed, for example, to provide dental cleaning benefits. Natural pet treats include rawhide and real bones. However, rawhide has been known to swell and cause blockages in the digestive tract of an animal, and real bones are able to splinter and cause lacerations. Rawhide and real bones also harbor bacteria that can pose a threat to both humans and animals.

On the other end of the spectrum, synthetic toys and bones, which are made of plastic, avoid many of the problems associated with rawhide and real bones. However, these products are non-consumables that provide no nutritional benefits, and they are generally less appealing to both owners and pets than natural products.

Man-made pet treats are favored by many owners who wish to avoid the potential health problems of natural treats and the artificial characteristics of synthetic toys and bones. Generally, man-made treats contain thoroughly ground and mixed ingredients that are extruded to produce a product with a smooth texture. This smooth texture, however, tends to resemble the unnatural and unappealing texture of the synthetic products described above.

### SUMMARY

The present instrumentalities advance the art and overcome the problems outlined above by providing pet treats with rough surface texture and appearance and methods for producing the same.

In one aspect, a profile-extruded treat with rough surface texture and appearance includes a matrix binder selected from the group consisting of gelatinized starches, gelatinized flours, wheat gluten, soy protein, casein, caseinates, gelatin, hydrocolloids, gums and mixtures thereof and at least one granular filler having a particle size between 0.1 mm to 6 mm, said granular filler being selected from the group consisting of whole grain fillers, distiller's dried grains and mixtures thereof.

In one aspect, a method of making a profile-extruded pet treat with rough surface texture and appearance includes the steps of mixing ingredients including a matrix binder selected from the group consisting of gelatinized starches, gelatinized flours, wheat gluten, soy protein, casein, caseinates, gelatin, hydrocolloids, gums and mixtures thereof and at least one granular filler having a particle size between 0.1 mm to 6 mm, said granular filler being selected from the group consisting of mill feeds, whole grains, distillers dried grains, pork grind, bird seed and mixtures thereof, and extrusion shaping the pet treat.

### BRIEF DESCRIPTION OF THE DRAWINGS

FIG. 1 shows a side perspective view of a cylindrical profile-extruded pet treat with rough surface texture and appearance, according to an embodiment;

FIG. 2 shows a cross-sectional view of the profile-extruded pet treat shown in FIG. 1;

FIG. 3 shows a side perspective view of a tubular profile-extruded pet treat with rough surface texture and appearance, according to an embodiment;

FIG. 4 shows a cross-sectional view of the profile-extruded pet treat shown in FIG. 3;

FIG. 5 shows a top perspective view of a rectangular profile-extruded pet treat with rough surface texture and appearance, according to an embodiment;

FIG. 6 shows a cross-sectional view of the profile-extruded pet treat shown in FIG. 5

FIG. 7 shows a side perspective view of a cylindrical profile-extruded pet treat with rough surface texture and appearance, according to an embodiment;

FIG. 8 shows a cross-sectional view of the profile-extruded pet treat shown in FIG. 7;

FIG. 9 shows a side perspective view of a ridged profile-extruded pet treat with rough surface texture and appearance, according to an embodiment; and

FIG. 10 shows a cross-sectional view of the profile-extruded pet treat shown in FIG. 9.

### DETAILED DESCRIPTION

Profile-extruded treats with rough surface texture and appearance are described herein. The disclosed treats have a natural look and a rough surface texture that appeals to owners and pets.

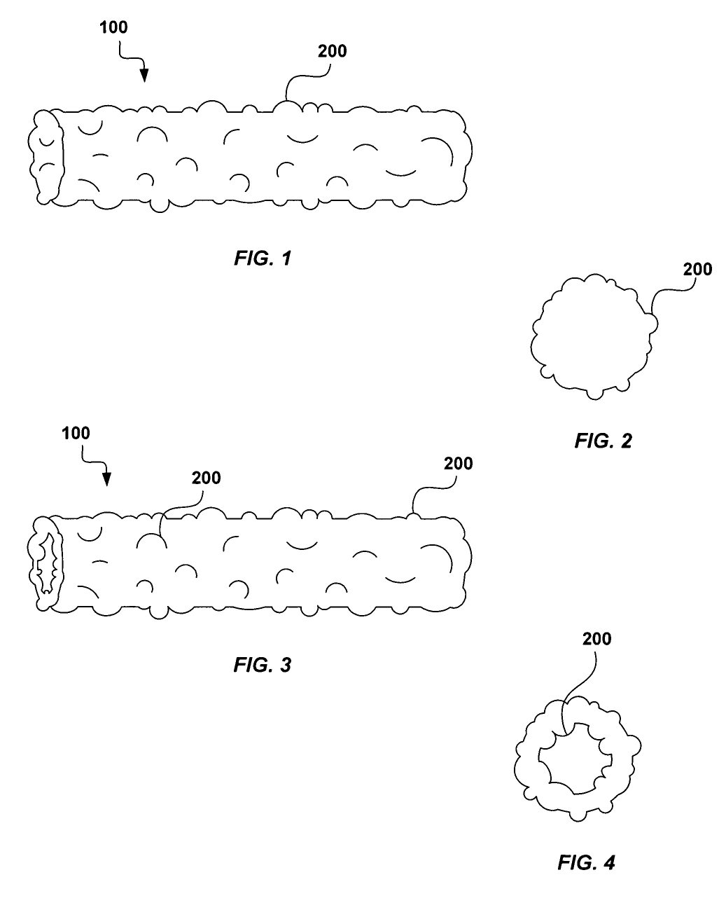

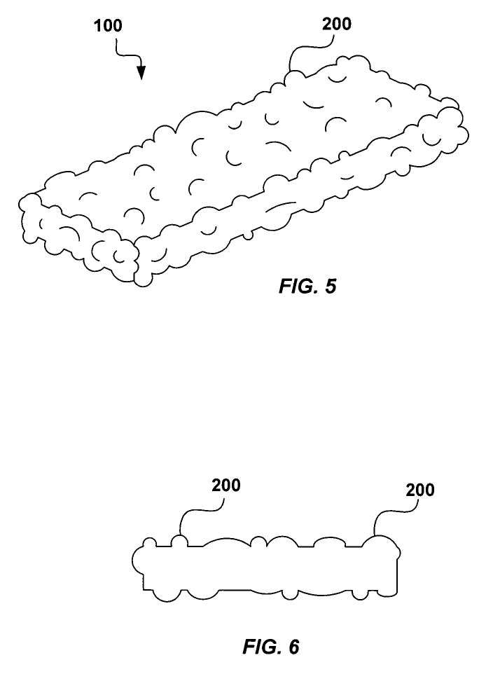

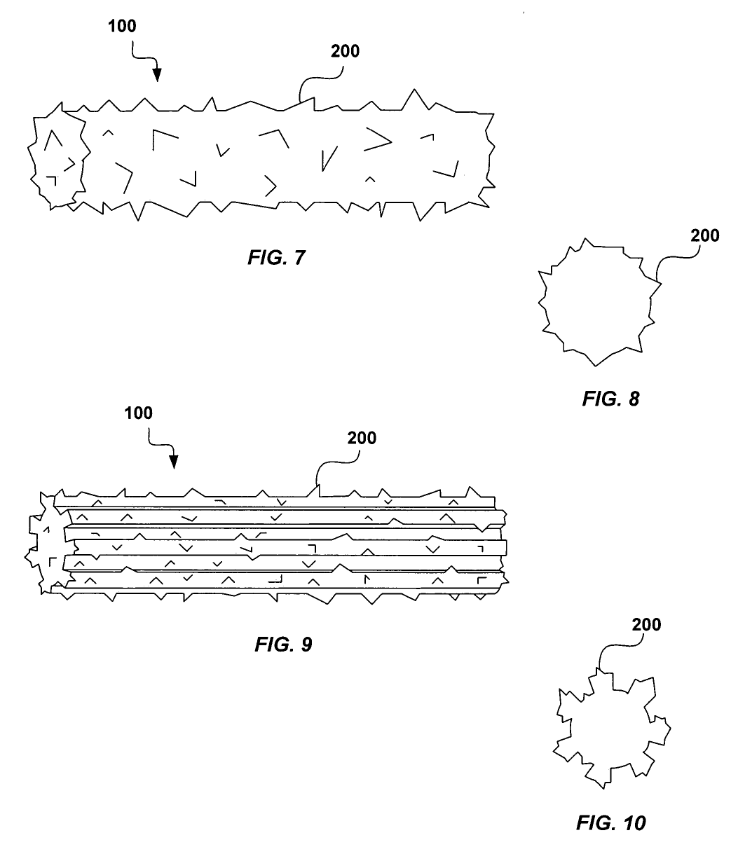

FIGS. 1-10 show profile-extruded pet treats 100 with rough surface texture and appearance, along with corresponding cross-sectional views. It will be appreciated that the disclosed pet treats may be formed into various shapes and sizes, which may or may not be illustrated in the accompanying Figures. The rough texture of the treats 100 may be attributed to granular fillers 200 that protrude from surfaces of the treats 100.

Profile-extruded pet treats disclosed herein are created by combining a matrix binder with granular fillers having a particle size between 0.1 mm to 6 mm.

Suitable matrix binders include gelatinized starches, gelatinized flours, wheat gluten, soy protein, casein, caseinates, gelatin, hydrocolloids, gums and mixtures thereof. Matrix binder content is typically from 15%-85% by weight of the final product.

Suitable fillers include mill feed; pork grind (both raw and rendered); whole grains; middling from wheat, corn, or soy; distiller's dried grain (DDG); chopped and dried carrots; roast peanut coarse grits; coarse corn grits; coarse rice grits; oat meal flakes; bird seed; and mixtures thereof. Filler content is typically from 15%-85% by weight of the final product.

Plasticizers, such as glycerine, propylene glycol or mixtures thereof, may be present from 5-25% by weight of the final product. The plasticizer helps control the ductility of the product. Water may be added to the formulation such that the moisture content of the product is from 5-15% by weight.

Other minor ingredients, such as colorants, vitamins, minerals, lubricants, humectants, palatibility enhancers, fibers, dental cleaning ingredients, breath freshening agents, flavoring agents, antioxidants, and emulsifiers, may be included in the formulations disclosed herein. For example, fibers may include cellulose fiber, sisal fiber, nylon/polyester fiber, hemp fiber, wheat bran, innulin and mixtures thereof. Dental cleaning agents may include fillers and/or phosphates. Breath-freshening agents may include chlorophyll, mint, parsley, and/or kelp. Flavoring agents may include garlic flavor, meat flavors, cheese flavors, fruit flavors, and smoke flavors. Antioxidants can be both natural and synthetic. Colorants may include both natural and synthetic dyes or pigments including titanium dioxide. It is preferable that such additional ingredients individually comprise less than 5% by weight of the final product.

Preferred pet treats may contain less than 1% by weight of lubricants. Such lubricants help prevent the products from sticking to one another. The lubricants may include, for example, glycerol monostearate, glycerol monolaurate, hydrolyzed lecithin and derivatives, hydrolyzed vegetable oils, magnesium stearate, and calcium stearate. One preferred lubricant is glycerol monostearate.

Palatability enhancers are used in numerous pet treats to attract the animal to the food item. The palatability enhancer is preferably selected from the group consisting of meat and poultry broth concentrate or spray-dried powder, liver and liver digest broth concentrate or powder, hydrolyzed proteins, and yeast and yeast extract. One particularly preferred palatability enhancer is from a liver source.

In the past, humectants such as sorbitol, mannitol, sugars, and reducing sugars have been utilized in pet treat formulations for helping the products maintain moisture. The use of such humectants is presently undesirable, though their use is not necessarily proscribed.

The profile product is made by extrusion using a single-screw or twin-screw extruder. The temperature of extrusion is controlled from 50-120° C. for the melt mixture inside the barrel. Extrudate coming out the shaping die is cut into lengths of ⅛″ to 12″. The profile is cooled or further cured with heat or steam before being cooled for final packaging. Embossing or additional shaping of three-dimensional features may optionally be performed before or after cutting.

While any type of extrusion apparatus is suitable for use with the disclosed formulations and methods, it is preferable to use a twin-screw extruder. Preferably the mixture is then passed through one or more insert dies thereby forming extrudate strands. The die(s) may be configured so as to produce an extrudate strand having a particular cross-sectional profile, with examples of simple profiles being rectangular, circular, and club-shaped. The strand thickness is specially chosen depending upon the size of pet ultimately intended to consume the pet treat. Preferably, the extrudate strand will have a thickness of about ¼ to 1½ inches and more preferably from about ⅜″ to 1 inch. The extrudate can also be in the form of a curved up sheet to simulate rawhide looking products. The extrudate is placed on a conveying belt for partial cooling. The extrudate strands are cut at the end of conveying belt and transferred to a cooler for cooling to room temperature. After exiting the cooler, the products can be packaged in canisters, zip-lock bags or pouches, hot melt sealed bags, etc.

Proper packaging improves the quality of products delivered to the ultimate consumer. Exemplary packaging materials include aluminum-plastic film laminates, PET, PVC, PS, PP thermoforms, PVP based-laminates, PE, PP films, and the like.

The following examples teach by way of illustration, and not by limitation, to illustrate preferred embodiments of what is claimed.

### EXAMPLE 1

STARCH-BASED FORMULATION INCLUDING
DISTILLERS DRIED GRAINS (DDG)

| | |
|---|---|
| Midsol Pregel 10 (gelatinized wheat starch)* | 59.5 parts |
| Distillers Dried Grains (DDG)* | 40 parts |
| Glycerol Monostearate | 0.5 parts |
| Glycerine | 22 parts |
| Water | 10 parts |

The above formulation was prepared using a Wenger TX-85 twin screw extruder. The extruder barrel temperature was set at 180° F. with an extrusion rate of 800 lbs/hr and a screw speed of 120 rpm.

### EXAMPLE 2

STARCH-BASED FORMULATION INCLUDING
RENDERED PORK GRIND

| | | |
|---|---|---|
| Midsol Pregel 10 (gelatinized wheat starch)* | 45.5 | parts |
| Pork Grind** | 50 | parts |
| CHX-H Base Palatability Enhancer*** | 4 | parts |
| Glycerol Monostearate | 0.5 | parts |
| Red 40 Al lake (38%) | 0.01 | parts |
| Glycerine | 20 | parts |
| Water | 8 | parts |

The above formulation was prepared using a Wenger TX-57 twin screw extruder. The extruder barrel temperature was set at 180° F. with an extrusion rate of 200 lbs/hr and a screw speed of 100 rpm.

### EXAMPLE 3

PROTEIN-BASED FORMULATION INCLUDING BIRD SEED

| | | |
|---|---|---|
| Vital Wheat Gluten* | 55.5 | parts |
| Bird Seed Mix | 40 | parts |
| CHX-H Base Palatability Enhancer*** | 4 | parts |
| Glycerol Monostearate | 0.5 | parts |
| Glycerine | 22 | part |
| Water | 6 | parts |

The above formulation was prepared using a Wenger TX-57 twin screw extruder. The extruder barrel temperature was set at 200° F. with an extrusion rate of 200 lbs/hr and a screw speed of 100 rpm.

* Provided by MGP Ingredients, Inc., Atchison, Kans.

** Provided by Rudolph Foods Company, Inc., Lima, Ohio

*** Provided by Applied Food Biotechnology Inc., O Fallon, Mo.

Changes may be made in the above systems and methods without departing from the subject matter described in the Summary and defined by the following claims. It should thus be noted that the matter contained in the above description should be interpreted as illustrative and not limiting.

All references cited are incorporated by reference herein.

1. A profile-extruded treat with rough surface texture and appearance comprising:
a matrix binder selected from the group consisting of gelatinized starches, gelatinized flours, wheat gluten, soy protein, casein, caseinates, gelatin, hydrocolloids, gums and mixtures thereof; and
at least one granular filler having a particle size between 0.1 mm to 6 mm, said granular filler being selected from the group consisting of mill feeds, whole grains, distillers dried grains, pork grind, bird seed and mixtures thereof.

2. The profile-extruded treat of claim 1, wherein said matrix binder comprises from 15-85% by weight based on the weight of the final product.

3. The profile-extruded treat of claim 1, wherein said granular filler comprises from 15-85% by weight based on the weight of the final product.

4. The profile-extruded treat of claim 1 further comprising a plasticizer.

5. The profile-extruded treat of claim 4, wherein the plasticizer is selected from the group consisting of glycerine, propylene glycol and mixtures thereof.

6. The profile-extruded treat of claim 4, wherein the plasticizer comprises from 5-25% by weight based on the weight of the final product.

7. The profile-extruded treat of claim 1 further comprising an additional ingredient selected from the group consisting of a colorant, a vitamin, a mineral, a lubricant, a humectant, a palatibility enhancer, a fiber, a dental cleaning ingredient, a breath freshening agent, a flavoring agent, an antioxidant, an emulsifier and mixtures thereof.

8. The profile-extruded treat of claim 7, wherein the fiber is selected from the group consisting of cellulose fiber, sisal fiber, nylon/polyester fiber, hemp fiber, wheat bran, innulin and mixtures thereof.

9. The profile-extruded treat of claim 7, wherein the breath-freshening agent is selected from the group consisting of chlorophyll, mint, parsley, kelp and mixtures thereof.

10. The profile-extruded treat of claim 7, wherein the flavoring agent is selected from the group consisting of garlic flavor, meat flavors, cheese flavors, fruit flavors, smoke flavors and mixtures thereof.

11. The profile-extruded treat of claim 7, wherein the lubricant is selected from the group consisting of glycerol monostearate, glycerol monolaurate, hydrolyzed lecithin, hydrolyzed vegetable oils, magnesium stearate, calcium stearate and mixtures thereof.

12. The profile-extruded treat of claim 7, wherein the palatability enhancer is selected from the group consisting of meat broth concentrate, poultry broth concentrate, meat broth spray-dried powder, poultry broth spray-dried powder, liver broth concentrate, liver digest broth concentrate, liver broth powder, liver digest broth powder, hydrolyzed proteins, yeast, yeast extract and mixtures thereof.

13. The profile-extruded treat of claim 7, wherein the additional ingredient comprises less than 5% by weight of the final product.

14. A method of making a profile-extruded pet treat with rough surface texture and appearance, the method comprising the steps of:
mixing ingredients including:
a matrix binder selected from the group consisting of gelatinized starches, gelatinized flours, wheat gluten, soy protein, casein, caseinates, gelatin, hydrocolloids, gums and mixtures thereof, and
at least one granular filler having a particle size between 0.1 mm to 6 mm, said granular filler being selected from the group consisting of mill feeds, whole grains, distillers dried grains, pork grind, bird seed and mixtures thereof; and
extrusion shaping the pet treat.

15. The method of claim 14, wherein said matrix binder comprises from 15-85% by weight based on the weight of the final product.

16. The method of claim 14, wherein said granular filler comprises from 15-85% by weight based on the weight of the final product.

17. The method of claim 14 further comprising a plasticizer selected from the group consisting of glycerine, propylene glycol and mixtures thereof.

18. The method of claim 17, wherein the plasticizer comprises from 5-25% by weight based on the weight of the final product.

19. The method of claim 14, further comprising an additional ingredient selected from the group consisting of a colorant, a vitamin, a mineral, a lubricant, a humectant, a palatibility enhancer, a fiber, a dental cleaning ingredient, a breath freshening agent, a flavoring agent, an antioxidant, an emulsifier and mixtures thereof.

20. The method of claim 19, wherein the additional ingredient comprises less than 5% by weight of the final product.
